(19) United States
(12) Patent Application Publication
(10) Pub. No.: US 2026/0163374 A1
(43) Pub. Date: Jun. 11, 2026

(54) CONTROL DEVICE

(71) Applicant: NTT DOCOMO, INC., Tokyo (JP)

(72) Inventors: Masaki NAKAMURA, Chiyoda-ku (JP); Yuta TOYAMA, Chiyoda-ku (JP); Kazuhiko TAKENO, Chiyoda-ku (JP)

(73) Assignee: NTT DOCOMO, INC., Tokyo (JP)

(21) Appl. No.: 18/872,304

(22) PCT Filed: May 31, 2023
(86) PCT No.: PCT/JP2023/020241

§ 371 Date: Dec. 6, 2024

(30) Foreign Application Priority Data
Jul. 25, 2022 (JP) 2022-117902

(51) Int. Cl. H02J 3/008; H02J 7/00; H02J 13/183

(52) U.S. Cl. CPC H02J 3/008; H02J 7/865; H02J 13/183

(57) ABSTRACT

An objective is to provide a control device that appropriately controls charging and discharging in a storage battery of a DC power supply system with respect to a power control request such as a demand response request.

The server 100 is a control device that performs power control for one or more base stations 1 to n (facilities) including a communication device 13 (a load device) and a storage battery that supplies electric power to the communication device 13. In the server 100, a DR request communication unit 101 receives a DR request (a power control request) from a power supplier. A base station selection unit 107 selects a base station being a DR request target on the basis of a type of storage battery of each of the one or more base stations. The type of storage battery is, for example, a lithium-ion battery or a lead-acid battery, and indicates a different degree of deterioration due to charging and discharging.

### TECHNICAL FIELD

The present invention relates to a control device for controlling a DC power supply system having a storage battery.

### BACKGROUND ART

In recent years, as a utilization proportion of natural energy used by a power supplier has increased, attention has been paid to a power supply and demand adjustment called a demand response (DR).

Because an amount of electric power generated by natural energy based on solar power generation or wind power generation increases or decreases with weather (a solar radiation amount, a wind amount, or the like), a power adjustment for flexibly coping with such fluctuations is necessary and a DR is one measure for achieving the power adjustment. In relation to the DR, a demand adjustment (DR) request for power from a power supplier to a consumer is made and incentives such as rewards are given in accordance with a suppressed amount of each consumer and a penalty is paid when a required amount is not satisfied beyond an error.

In Patent Literature 1, a required amount for each consumer in the DR request and a scheduled DR issuance time are predicted and storage battery control for each consumer is executed on the basis of the prediction. Here, the predictions of the scheduled DR issuance time and the DR-specific required amount are collectively referred to as DR activation prediction. In Patent Literature 1, the DR activation prediction is calculated by logistic regression using parameters highly related to power demand such as a power prediction utilization rate presented by a power supplier and power wholesale prices on a wholesale power exchange.

### CITATION LIST

### Patent Literature

[Patent Literature 1] Japanese Unexamined Patent Publication No. 2018-33273

### SUMMARY OF INVENTION

### Technical Problem

By controlling a storage battery in a DC power supply system so that an amount of stored electric power is maximized in response to a demand response request (DR request) received from a power supplier, it is possible to reduce the power supply to the maximum extent possible in response to the DR request and maximize the rewards obtained from the power supplier.

In the case of the DR using a group of base stations, there is a problem that the duration and control amount at the time of DR activation differ according to the base station because the backup capacity and load capacity of the storage battery to be reserved for disasters differ according to the base station.

For this reason, it is difficult to continuously provide a certain control amount at the DR activation time and therefore a process in which base stations perform discharging in cooperation with each other to satisfy the DR-specific required amount and duration by relay control of the base station is conceivable.

On the other hand, in recent years, the importance of strengthening power backup for wireless communication, reducing peak power demand, and the like has increased amid the need to enhance responses to severe disasters and stabilize power demand. Base stations are equipped with backup batteries in case of a power outage in the power system. Also, by storing power in a storage battery when the power demand is low and discharging the storage battery with the power stored therein when the power demand increases, the load on the power system can be reduced, leading to the peak reduction in power demand.

However, deterioration may be accelerated according to a type of storage battery by repeating charging and discharging.

Therefore, an objective of the present invention is to provide a control device for appropriately controlling charging/discharging in a storage battery of a DC power supply system in response to a power control request such as a demand response request.

### Solution to Problem

According to the present invention, there is provided a control device for performing power control for one or more facilities including a load device and a storage battery for supplying electric power to the load device, the control device including: a reception unit configured to receive a power control request from a power supplier; and a control unit configured to select a facility being a target of the power control request on the basis of a type of storage battery of each of the one or more facilities.

### Advantageous Effects of Invention

According to the present invention, it is possible to appropriately control a process of charging and discharging a storage battery in a DC power supply system in accordance with a DR request.

### BRIEF DESCRIPTION OF DRAWINGS

FIG. 1 is a diagram showing a system configuration of a DC power supply system of the present disclosure.

FIG. 2 is a diagram showing a functional configuration of a base station 1.

FIG. 3 is a diagram showing a functional configuration of a server 100 of a first embodiment of the present disclosure.

FIG. 4 is a flowchart showing an operation when the server 100 receives a DR request (downward DR).

FIG. 5 is a flowchart showing an operation when the server 100 receives a DR request (upward DR).

FIG. 6 is a conceptual diagram of a DR-specific required amount.

FIG. 7 is a diagram of a case where a base station is added and reselected within a conceptual diagram of a DR-specific required amount.

FIG. 8 is a graph of a load voltage, an output current of a rectifier, and a discharge current of a storage battery when recovery charging occurs.

FIG. 9 is a block diagram showing a functional configuration of a server 100a of a second embodiment of the present disclosure.

FIG. 10 is a flowchart showing an operation at the time of a downward DR of the server 100a.

FIG. 11 is a flowchart showing an operation at the time of an upward DR of the server 100a.

FIG. 12 is a schematic diagram of a case where base station selection indicating a base station failure is performed.

FIG. 13 is a schematic diagram of a case where one of the base stations is discharged and extended.

FIG. 14 is a diagram showing an example when a buffer station is added.

FIG. 15 is a diagram showing an example of a hardware configuration of the server 100 according to an embodiment of the present disclosure.

### DESCRIPTION OF EMBODIMENTS

Embodiments of the present disclosure will be described with reference to the accompanying drawings. If possible, identical parts are denoted by the same reference signs and redundant description will be omitted.

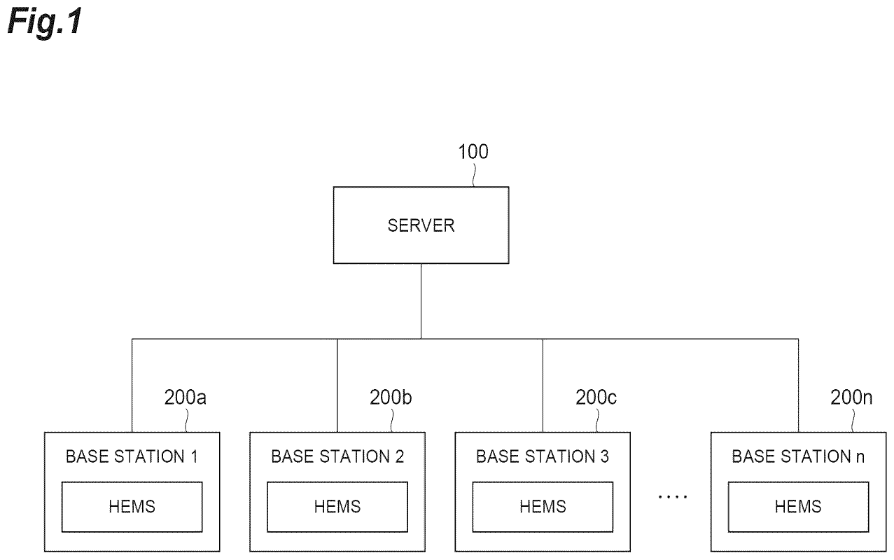

FIG. 1 is a diagram showing a system configuration of a DC power supply system of the present disclosure. As shown in FIG. 1, the DC power supply system includes a server 100 and a plurality of base stations 1 to n. The base stations 1 to n include home energy management systems (HMESs) 200a to 200n. The base stations 1 to n include a storage battery such as a lead-acid battery or a lithium-ion battery. If a demand response (DR) request is received, the server 100 instructs each of the base stations 1 to n to discharge or charge the storage battery.

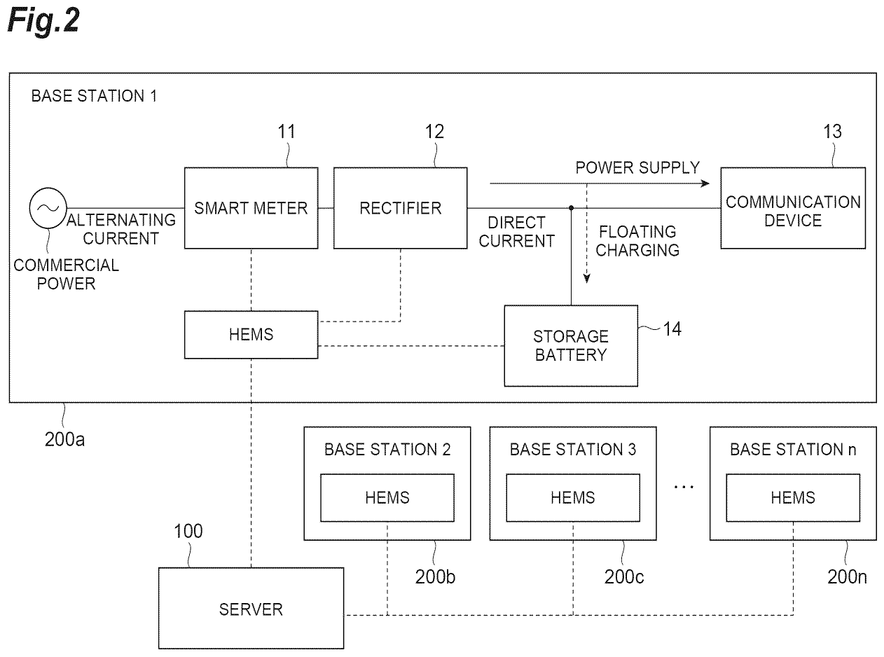

FIG. 2 is a diagram showing a functional configuration of the base station 1. The base stations 2 to n also have the same functional configuration. The base station 1 includes a smart meter 11, a rectifier 12, a communication device 13, a storage battery 14, and a HEMS 200a.

The smart meter 11 is a meter that measures an amount of used electricity received from commercial power.

The rectifier 12 is a circuit that converts an alternating current from commercial power into a direct current.

The communication device 13 is a portion corresponding to a load device that receives the supply of electric power output from the rectifier 12.

The storage battery 14 is a battery that is charged from commercial power and stores electricity, and the storage battery 14 is discharged in accordance with the voltage of the rectifier 12 to supply electric power to the communication device 13.

The HEMS 200a is a management device and is a portion that controls the smart meter 11, the rectifier 12, and the storage battery 14. When the HEMS 200a receives a signal from the server 100 that organizes a remote base station group, the output voltage of the rectifier is controlled. This output voltage control indicates that the voltage is set to be high in the case of a consumption request (upward DR) and the voltage is set to be low in the case of a power-saving request (downward DR).

That is, the HEMS 200a controls a voltage of the rectifier 12 in accordance with an instruction from the server 100 and controls a process of charging or discharging the storage battery 14. Moreover, the HEMS 200a transmits B route data of the smart meter 11 as a DR performance report to the server 100 together with the output power of the rectifier 12 and the current capacity W of the storage battery 14.

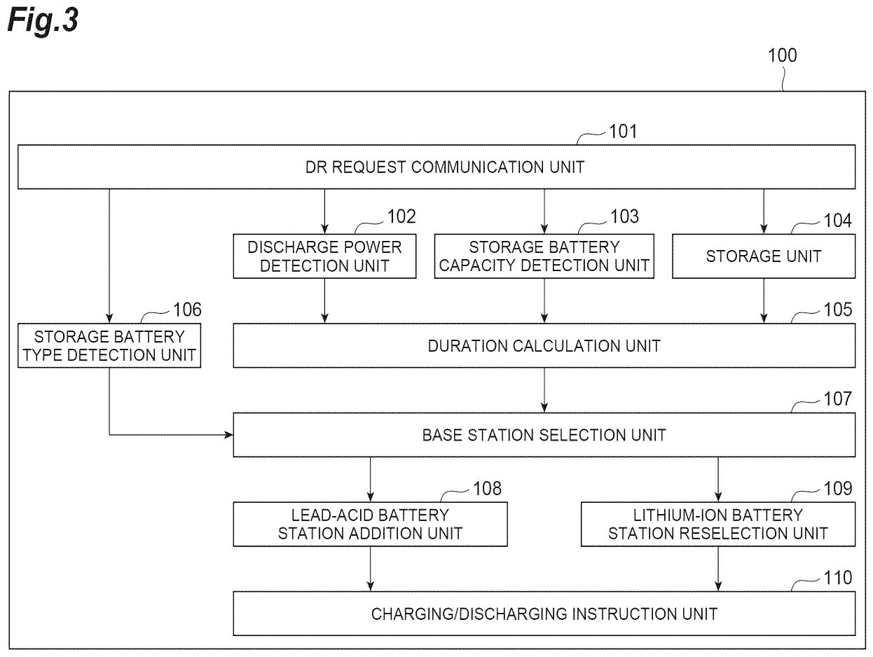

FIG. 3 is a diagram showing a functional configuration of the server 100 of the present disclosure. As shown in FIG. 3, the server 100 is configured to include a DR request communication unit 101, a discharge power detection unit 102, a storage battery capacity detection unit 103, a storage unit 104, a duration calculation unit 105, a storage battery type detection unit 106, a base station selection unit 107, a lead-acid battery station addition unit 108, a lithium-ion battery station reselection unit 109, and a charging/discharging instruction unit 110.

The DR request communication unit 101 receives a DR request from a power supplier and transmits a DR response to the power supplier. The DR request includes a required amount of a power-saving/consumption request, a request start time, and a request time. The DR request communication unit 101 also has a function of acquiring output power of the rectifier 12 or the like at the base station 1 or the like other than these DR requests.

The discharge power detection unit 102 is a portion configured to detect output power from the rectifier 12. This output power is acquired via the HEMS 200.

The storage battery capacity detection unit 103 is a portion configured to acquire a current capacity W from the storage battery 14. The current capacity W of the storage battery 14 is acquired via the HEMS 200.

The storage unit 104 stores a backup capacity W_{bu} of the storage battery 14 for disasters to be secured by each base station. This backup capacity W_{bu} is predetermined information.

The duration calculation unit 105 is a portion configured to calculate a duration of discharging or charging at each base station. That is, the duration calculation unit 105 calculates the discharging duration on the basis of the current capacity W, the backup capacity W_{bu}, and the output power of the storage battery 14. The discharge power P at the time of the downward DR is determined on the basis of the output power of the rectifier 12 of each base station before the DR activation time. For example, the discharge power P may be calculated by multiplying the output power by a predetermined coefficient, but the calculation method is not limited thereto.

Moreover, the duration calculation unit 105 calculates the charging duration on the basis of the current capacity W of the storage battery 14, a maximum capacity W_{FULL} of the storage battery, and the discharge power P.

The storage battery type detection unit 106 is a portion configured to detect the storage battery type of the storage battery 14 of each base station. The storage battery type is managed in the HEMS 200 and the storage battery type detection unit 106 acquires information of this type. In the present disclosure, there are lead-acid batteries and lithium-ion batteries as storage battery types, but other battery types may be included. Moreover, information indicating a degree of deterioration due to charging/discharging may be acquired as a type of battery.

The base station selection unit 107 is a portion configured to select a base station being a DR request target on the basis of the storage battery type detected in the storage battery type detection unit 106. Details will be described below.

The lead-acid battery station addition unit 108 is a portion to which a lead-acid battery station is added in accordance with a base station selection process of the base station selection unit 107. A lead-acid battery station is a base station with a lead-acid battery.

The lithium-ion battery station reselection unit 109 is a portion configured to reselect a lithium-ion battery station in accordance with a base station selection process of the base station selection unit 107. The lithium-ion battery station is a base station with a lithium-ion storage battery.

The charging/discharging instruction unit 110 is a portion configured to transmit a discharging or charging instruction for the storage battery at each base station to each base station in accordance with the DR request. The discharging instruction and the charging instruction include information indicating whether to perform charging or discharging, a charging/discharging start time, and charging/discharging duration. At that time, the charging/discharging instruction unit 110 performs control so that each base station (HEMS) performs charging/discharging for a specified time. In addition, the charging/discharging instruction unit 110 may be configured to transmit charging/discharging instructions to the corresponding base stations (HEMSs) one by one when the charging/discharging time is reached.

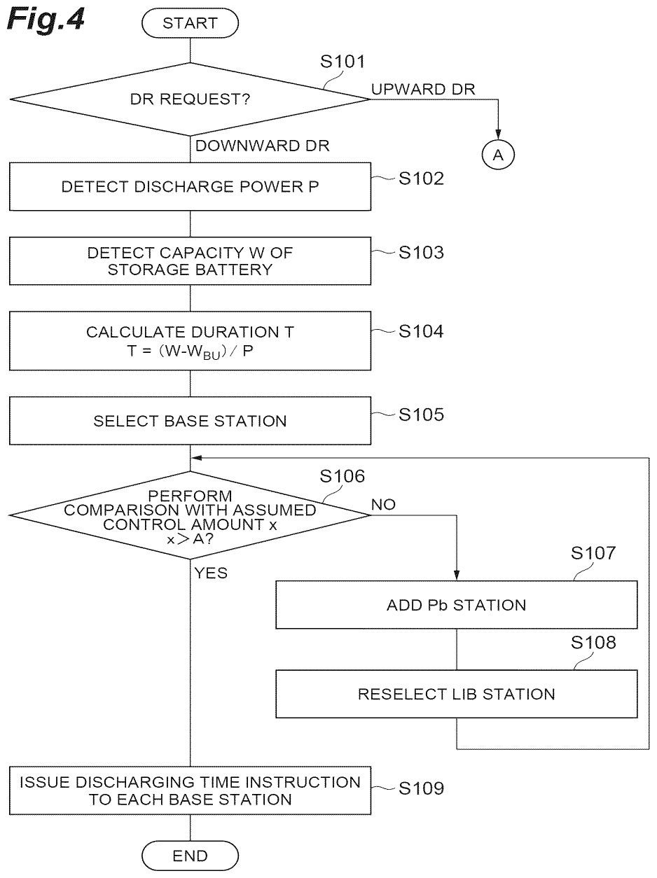

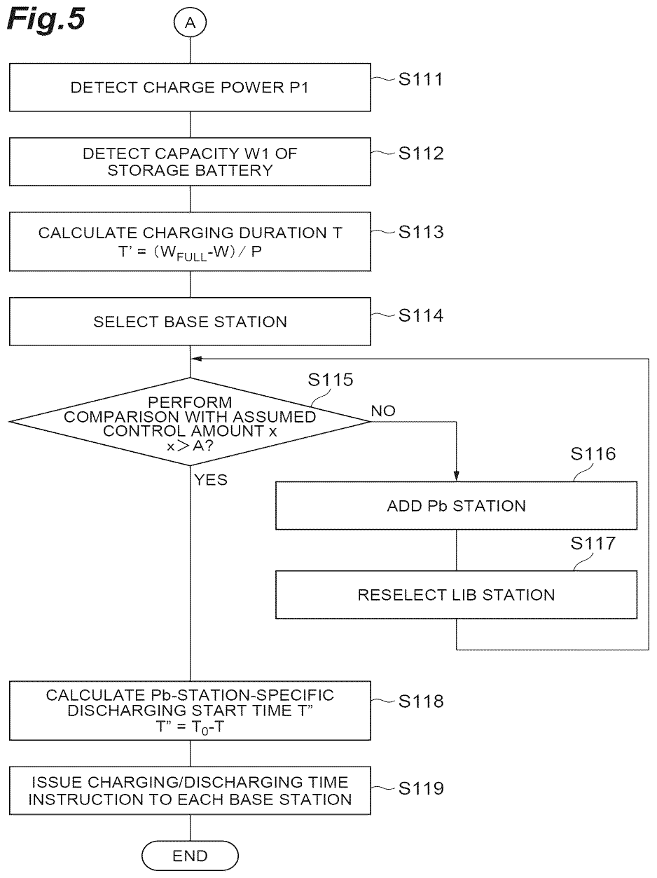

Next, the operation of the server 100 of the present disclosure will be described. In FIGS. 4 and 5, FIG. 4 shows a case where a downward DR request among DR requests is received. The downward DR request is a power-saving request.

The DR request communication unit 101 receives a DR request from the power supplier (S101). The DR request includes a DR start time, DR-specific duration, and a required amount. When the DR request communication unit 101 receives a downward DR request (S101: downward DR), the discharge power detection unit 102 detects the output power of the rectifier 12 at the time of the DR request by acquiring it from each base station (S102). The storage battery capacity detection unit 103 detects the storage battery capacity W that is the current capacity of each storage battery at each base station at the time of DR activation (S103).

The duration calculation unit 105 calculates duration T indicating a discharging time for the storage battery 14 at each base station in accordance with the following Eq. (1).

$$Duration T = ( W - {W}_{B U} ) / P \qquad ( 1 )$$

That is, the duration calculation unit 105 can calculate the discharging duration T of each base station (the storage battery 14) by dividing a difference obtained by subtracting the backup capacity W_{BU} from the current capacity (the storage battery capacity W) by the discharge power P based on the output power of the rectifier.

The base station selection unit 107 selects one or more base stations with lithium-ion batteries using the duration T and the discharge power P of the storage battery 14 of each base station (S105). This selection is made by the BL method. Moreover, the presence or absence of a lithium-ion battery is determined on the basis of the information detected by the storage battery type detection unit 106.

The base station selection unit 107 compares an assumed control amount X indicating a power control amount for all selected base stations with a DR-request-specific required amount A (S106).

Here, when the base station selection unit 107 does not have the assumed control amount X greater than the required amount A, the lead-acid battery station addition unit 108 selects a base station with a lead-acid battery (S107). Moreover, the lithium-ion battery station reselection unit 109 reselects the base station with the lithium-ion battery (S108).

On the other hand, when the base station selection unit 107 determines that the assumed control amount X is greater than the required amount A, the charging/discharging instruction unit 110 transmits a discharging time instruction to each base station selected by the BL method (S109). On the basis of this instruction, a discharging process is performed at each base station. The discharging time of each base station is determined in accordance with the displacement of the base stations placed by the BL method. For the base station selected by the BL method, a discharging time (including a start time) is determined according to its placement and a notification of the discharging time of the base station is provided.

Here, the processing steps S105 to S109 will be described in detail. The base station selection unit 107 determines whether the storage battery provided in the base station is a lead-acid battery or a lithium-ion battery from the storage battery type detection unit 106. Also, the base station selection unit 107 selects any base station from among the lithium-ion battery base stations so that the required amount A is satisfied on the basis of the discharge power P (charge power in the case of an upward DR) of the storage battery based on the output power of the rectifier of each base station and the discharging duration.

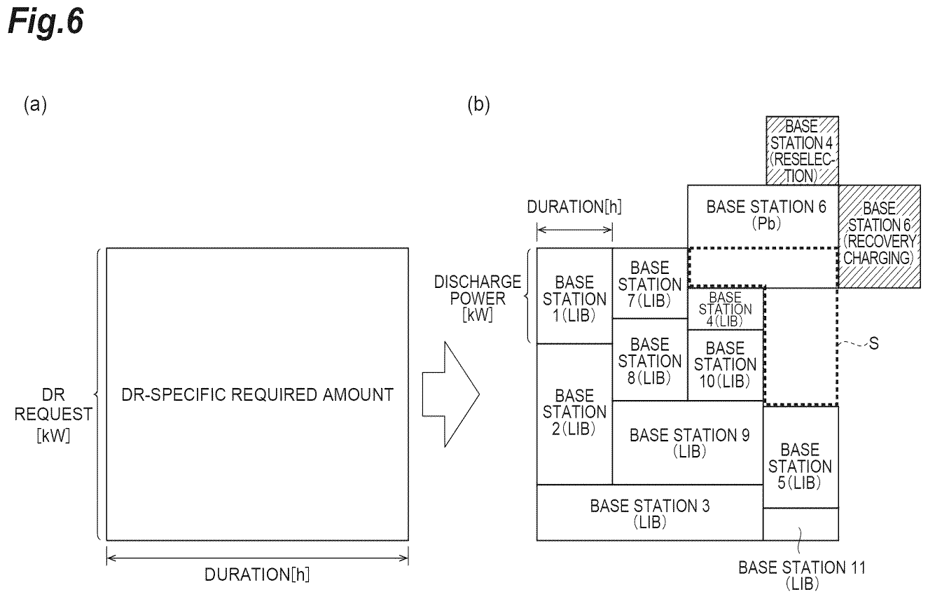

It is necessary to consider the following circumstances at the time of selection. It is difficult to continuously provide a certain control amount at the DR request time, and as shown in FIG. 6, it is necessary for base stations to perform discharging in cooperation with each other so that the DR-specific required amount and duration are satisfied according to the relay control of the base station. Because the load of the base station can be considered approximately constant (with some exceptions), the discharge power remains roughly constant over time. Therefore, a method of selecting the base station that best meets the total DR-specific required amount can be approached as solving a rectangle packing problem. Specifically, there are known methods such as a bottom-left algorithm (BL method) for placing items from the beginning of the order given in advance for the figure and packing the items as far down and as far left as possible if the height is the same and a bottom-right algorithm (BR method) for packing items as far down and as far right as possible if the height is the same.

FIG. 6(a) is a conceptual diagram of the DR-specific required amount. As shown in FIG. 6(a), the DR-specific required amount is determined on the basis of the duration (including a start time) of the DR request indicated in the DR request and its DR request (power). The DR-specific required amount is indicated in a concept of a rectangle (including a square: the same applies below) in which the vertical length is a DR request (the unit is kW) and the horizontal length is duration (the unit is h).

FIG. 6(b) is a diagram showing an example of a conceptual diagram in which the DR-specific required amount is packed with the control amount of each base station. As shown in FIG. 6(b), the control amount of each base station is shown in the concept of a rectangle in which the vertical length is discharge power (at the time of the downward DR) or charge power (both units are kW) and the horizontal length is duration (unit is h). As shown in FIG. 6(b), by packing the rectangles of the control amounts of the base stations into the rectangle of the DR-specific required amount (shown in FIG. 6(a)) from the left (from the early time period) as tightly as possible, it is possible to calculate the optimal combination of the control amounts of base stations that satisfies the DR-specific required amount.

As a feature of the BL method, the later the DR request time, the more the required amount tends not to be satisfied, and in the case of FIG. 6(b), a portion indicated by reference sign S does not satisfy the DR-specific required amount. This is the discharging time period of the base stations 4, 3, 9, and 10 and the discharging time period of the base stations 5 and 11.

At this time, the lead-acid battery station addition unit 108 treats a Pb station (a base station with a lead-acid battery) as discharging from a time period below the DR request to a DR end time. Also, the lead-acid battery station addition unit 108 selects a station with a largest discharge amount from among the Pb stations that satisfy the discharging time, and adds Pb stations sequentially until the DR-specific required amount is satisfied.

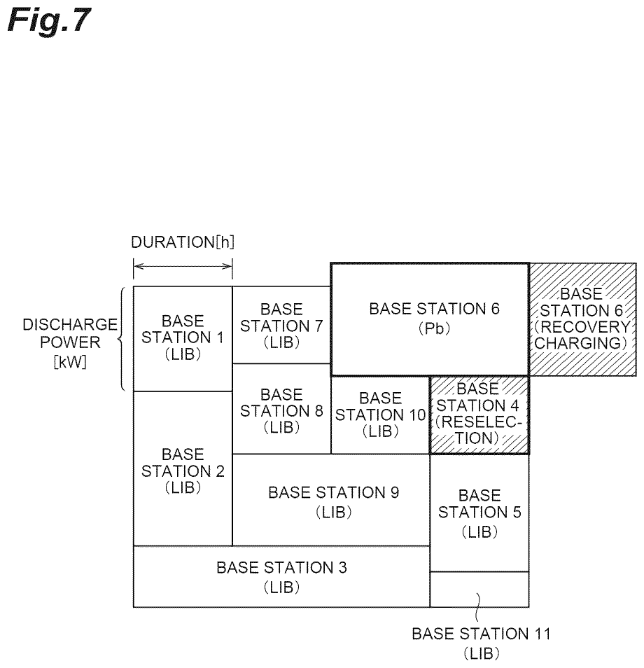

FIG. 7 is a schematic diagram showing a selection process based on the BL method when a Pb station is added and a LIB station is reselected. In the case of FIG. 6(b), because the base station 6 is determined to be discharged from the discharging start time of the base station 4 to the DR end time (the portion indicated by the DR-specific required amount in FIG. 6(a)), the DR-specific required amount can be satisfied without discharging the base station 4 during the discharging time period of the base station 4. Therefore, the LIB station is reselected so that the base station 4 is also discharged during the discharging time period of the base station 5. Thereby, it is possible to control the selection of the base station in response to the DR request that minimizes the addition of a Pb station. The LIB station indicates a base station with a lithium-ion battery.

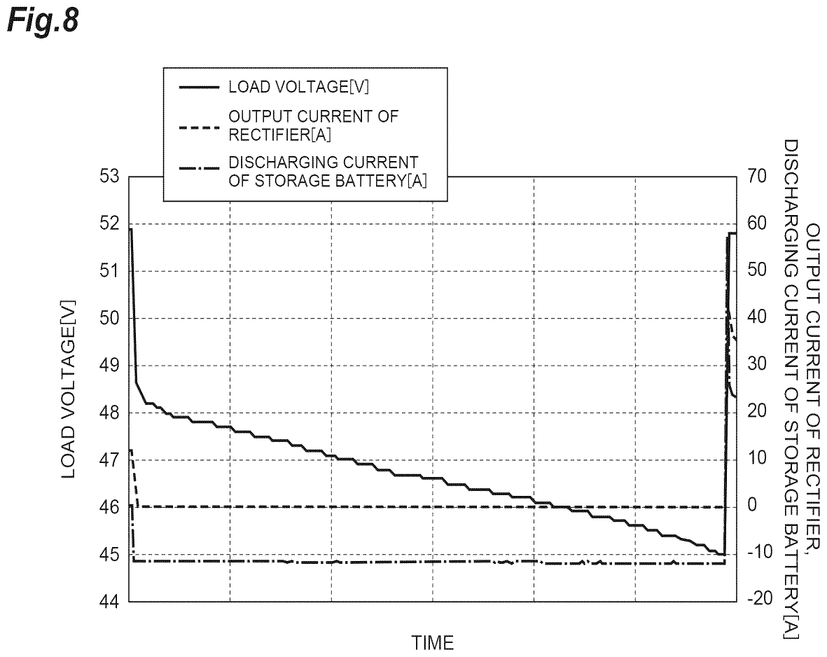

Meanwhile, the base station 6 will perform recovery charging immediately after the DR end time, but there is no problem because it is outside the DR activation time. Because the DC power supply system of the present disclosure employs a constant voltage charging (CV) method, recovery charging occurs immediately after discharging toward a fully charged state as shown in FIG. 8. However, as described above, it is not necessary to consider recovery charging occurring outside the DR activation time. FIG. 8 is a graph for a load voltage, a rectifier-specific output current, and a storage-battery-specific discharging current. This graph shows a case where recovery charging for a lead-acid battery occurs.

In this way, if there is a time period when the DR request is not satisfied as a result of base station selection, the lead-acid battery station addition unit 108 and the lithium-ion battery station reselection unit 109 add a base station (a lead-acid battery station) with a lead-acid battery. Moreover, the lithium-ion battery station reselection unit 109 reselects a base station (a lithium storage battery station) with a lithium-ion battery as necessary. Moreover, the discharging start time of the base station placed by the BL method is obtained in accordance with placement.

Next, an operation of the server 100 when an upward DR request is received will be described on the basis of FIG. 5. When the DR request communication unit 101 receives an upward DR request (S101: upward DR), the storage battery capacity detection unit 103 detects charge power P1 (S111) and the storage battery capacity detection unit 103 detects a storage battery capacity W1 (S112).

The duration calculation unit 105 calculates charging duration T′ indicating the charging time of the storage battery at each base station in accordance with the following Eq. (2) (S113).

$$Duration {T}^{′} = ( {W}_{FULL} - W 1 ) / P 1 \qquad ( 2 )$$

That is, the duration calculation unit 105 can calculate the charging duration T′ of each base station by dividing the charge power P1 by a difference obtained by subtracting the current storage battery capacity W from the maximum capacity W_{FULL} of the storage battery.

The base station selection unit 107 selects one or more base stations with lithium-ion batteries using the charging duration T′ of each base station (S114). This selection is performed by the BR method. Moreover, the presence or absence of the lithium-ion battery is determined on the basis of information detected by the storage battery type detection unit 106. The reason for selecting the BR method is to use the recovery charging of the Pb station. Details will be described below.

The base station selection unit 107 compares an assumed control amount x indicating a power amount being a control target for all selected base stations with the required amount A being the DR request target (S115).

Here, when the base station selection unit 107 determines that the assumed control amount x is not greater than the required amount A, the lead-acid battery station addition unit 108 selects a base station with a lead-acid battery (S116). Moreover, the lithium-ion battery station reselection unit 109 reselects a base station with a lithium-ion battery (S117).

On the other hand, when the base station selection unit 107 determines that the assumed control amount x is greater than the required amount A, the base station selection unit 107 calculates a Pb-station-specific discharging start time T′ according to the following Eq. (3) (S118). T denotes a discharging time.

$${T}^{″} = {T}_{0} - T \qquad ( 3 )$$

For example, if the capacity of the lead battery is 10 kWh and the discharge power is 1 kW, the backup capacity (for example, 8 kWh) to be secured is pre-discharged by the DR start time T₀ (for example, 15:00). At this time, the discharging start time of the lead battery T″ is obtained as T″=T₀ (at 15:00)−T((10 kWh−8 kWh)/1 kW) and T″=13:00.

The charging/discharging instruction unit 110 transmits a charging/discharging time instruction to each base station (S119). That is, the charging/discharging instruction unit 110 transmits a charging instruction to the base station with a lithium-ion battery according to rectangles (DR requests of base stations) placed by the BR method and transmits the discharging instruction and the discharging start time T″ to the base station with a lead-acid battery in consideration of the recovery charging after the discharging described above.

In addition, the lithium-ion battery is not continuously fully charged, but is charged intermittently (the lithium-ion battery is self-discharged and charged if a battery level falls below a certain SOC). Therefore, it is not intentionally discharged for the upward DR. That is, a discharging timing of the lithium-ion battery is determined intermittently at any time.

Here, the processing steps S114 to S118 will be described in detail. Charge power P1 required for charging the storage battery of each base station is determined to be a unique value in accordance with the specifications of the lithium-ion battery provided in each base station. Moreover, the charging duration of each base station can be calculated by dividing a difference obtained by subtracting a current capacity from a full charging capacity by the charge power P1 that is determined previously. On the basis of information of each base station obtained in this way, a base station is selected by the BR method and relay control of the base station is performed. That is, according to the placement based on the BR method, the charging start time at each base station is determined.

In FIG. 6, in the BL method, the rectangles are packed in order from the bottom and packed in order from the left if the rectangles have the same height, but in this process, the rectangle packing problem by the BR method is processed. That is, the rectangles of the same height are packed in order from the bottom and the rectangles of the same height are packed from the right.

A feature of the BR method is that the earlier the DR request time, the less likely it is that the required amount will be satisfied. At this time, the Pb station is discharged in advance up to the backup capacity to be secured and the Pb station is added from a base station with a largest charge amount among base stations capable of being charged from the DR start time to the time when it is less than the required amount until the DR-specific required amount is satisfied. Subsequently, the LIB station is reselected as necessary.

Each base station is charged and discharged in accordance with the control of the HEMS 200 if a predetermined time is reached. The HEMS 200 in each base station performs charging and discharging by setting the rectifier-specific voltage V_{RF} (for example, 52 V) higher than the storage-battery-specific voltage V_{LIB} (for example, 48 V) at the time of charging, and setting the rectifier-specific voltage V_{RF} (for example, 45 V) lower than the storage-battery-specific voltage V_{LIB} (for example, 48 V) at the time of discharging. The rectifier-specific voltage to be set at the time of discharging is set to satisfy the backup capacity to be secured by each base station by taking advantage of the property that the storage-battery-specific voltage increases as a state of charge (SoC) of the voltage of the storage battery 14 increases.

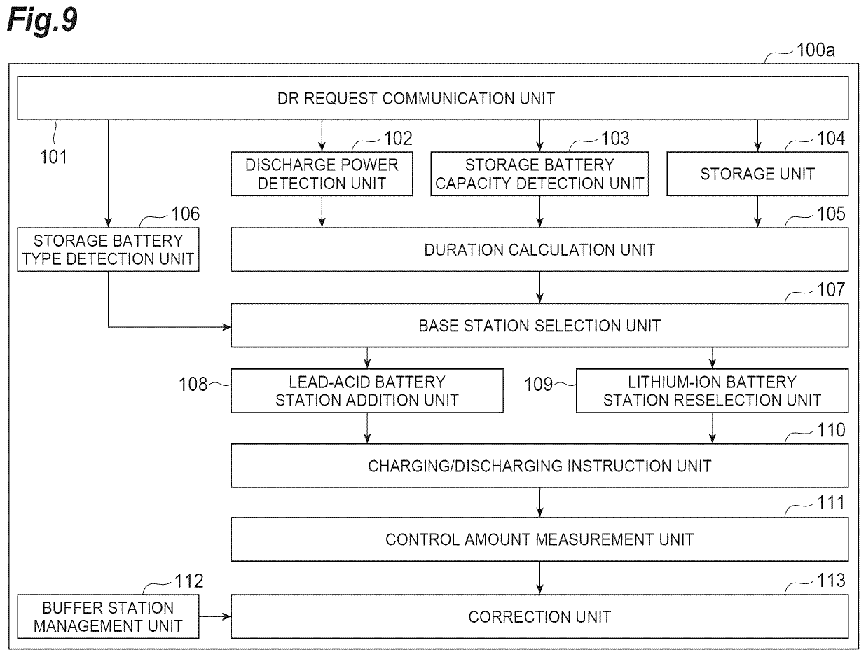

Next, the server 100a in the DC power supply system of the second embodiment will be described. FIG. 9 is a block diagram showing a functional configuration of the server 100a. The server 100a is configured to further include a control amount measurement unit 111, a buffer station management unit 112, and a correction unit 113 in addition to the server 100 of the DC power supply system of the first embodiment.

The server 100 of the first embodiment calculates an assumed control amount and issues an instruction for a discharging time (or charging/discharging time) to each base station so that the assumed control amount exceeds the required amount indicated in the DR request. On the other hand, for example, when a base station with a storage battery has failed during discharging, the server 100a adds a buffer station and corrects the discharging process of the correction station. Hereinafter, a process of adding a buffer station and the correction of a discharging process of the correction station will be mainly described. In addition, the buffer station is a base station that is not scheduled to participate in the DR and the correction station indicates a base station that has a spare capacity for charging and discharging among the base stations participating in the DR and that serves as a charging/discharging correction target.

The control amount measurement unit 111 is a portion configured to measure a real-time total power control amount at each base station (a sum of discharge power (or charge power) of each base station at time t).

The buffer station management unit 112 is a portion configured to add a base station (a buffer station) that is not scheduled to participate in the DR as a power control target when the power control amount does not reach the DR-specific required amount. That is, when the measured power control amount deviates from a predetermined range (for example, an error range) and falls below the measured power control amount, the buffer station management unit 112 determines that a failure or the like has occurred and operates to eliminate a difference between the power control amount and the required amount. In the present disclosure, the buffer station management unit 112 adds a base station that is not scheduled to participate in the DR.

In addition, the base station selection unit 107 stores information about the selected base station, and the buffer station management unit 112 uses the information to determine a base station that is not scheduled to participate in the DR. Moreover, the buffer station management unit 112 stores the duration for each base station obtained by the duration calculation unit 105 and the base station selection unit 107. On the basis of this information, the buffer station management unit 112 can ascertain a surplus discharging station group and a surplus charging station group.

That is, the buffer station management unit 112 can treat a base station with a storage battery of more than a predetermined SOC even after being discharged among the base stations selected by the BL method or the like as a surplus discharging station. Likewise, the buffer station management unit 112 can treat a base station with a storage battery of a predetermined SOC or less even after charging as a surplus charging station. The buffer station management unit 112 can determine a base station as a surplus charging/discharging station among the base stations being charging/discharging targets on the basis of the SOC of each storage battery.

The correction unit 113 is a portion configured to output an instruction to perform additional discharging for the added base station (buffer station), select a base station (a correction station) having a spare capacity for discharging beyond the duration, and output an instruction to perform an additional discharging process.

Such a function makes it possible to prepare for an unexpected situation during the DR activation time.

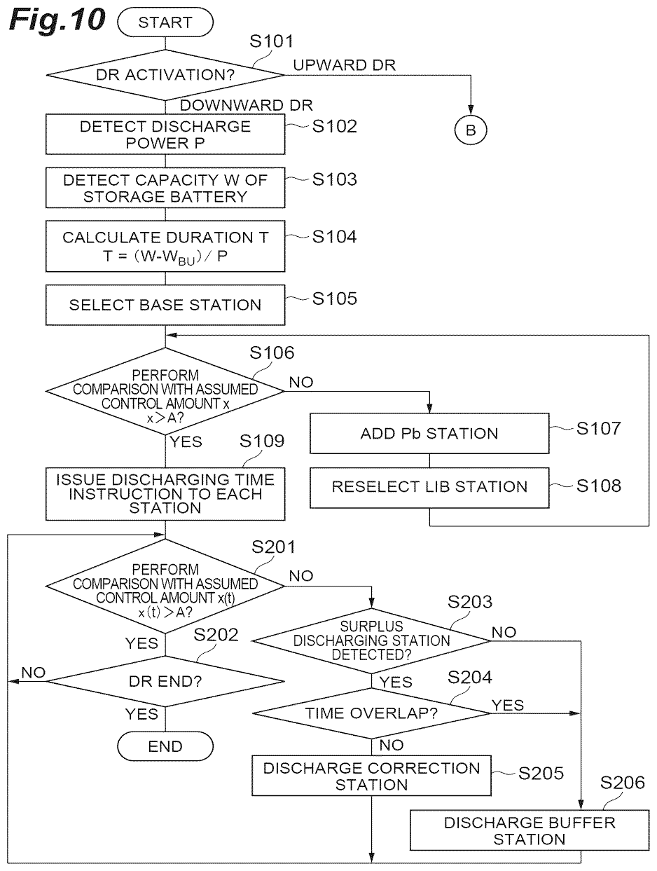

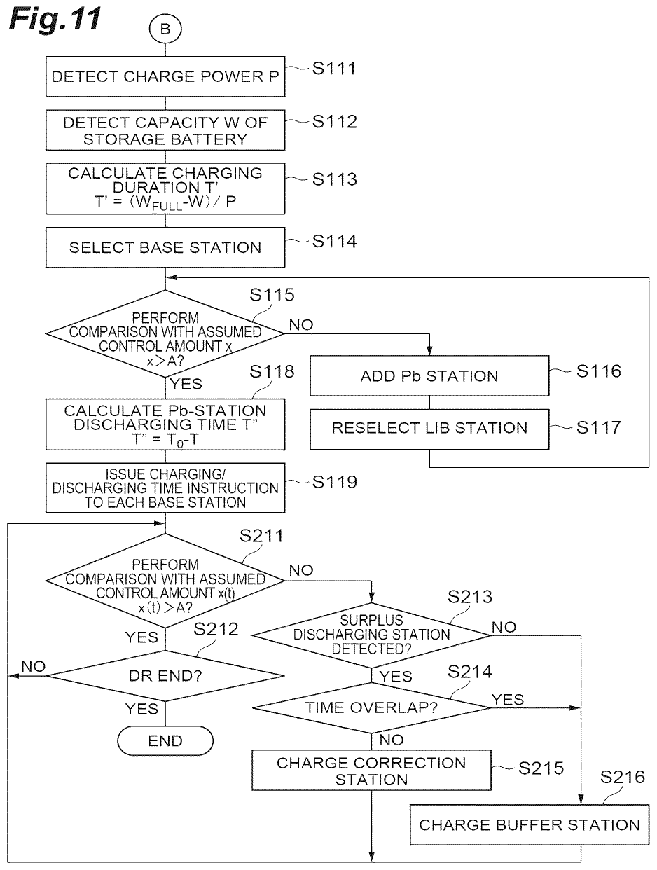

FIGS. 10 and 11 are flowcharts showing an operation of the server 100a. As shown in FIG. 10, the processing steps S101 to S109 are the same as in FIG. 4, the processing steps S111 to S119 shown in FIG. 10 are the same as in FIG. 5, and description thereof will be omitted.

The control amount measurement unit 111 measures the power control amount of each base station in real time and determines whether or not the power control amount has fallen below the required amount by deviating from the error range (S201). That is, the control amount measurement unit 111 determines whether or not a power control amount x(t) at time t is greater than a required amount A (a required amount at time t).

Here, when the power control amount x(t) is greater than the required amount A (the required amount at time t), the control amount measurement unit 111 iterates this check process until the DR is completed (S202).

When the power control amount falls below the required amount at time t during the DR activation time, the buffer station management unit 112 detects a base station (a surplus discharging station group) with a storage battery having a spare capacity for discharging beyond the duration from among the base stations that are power control targets based on the DR (S203).

When there is no surplus discharging station, the buffer station management unit 112 selects a base station (a buffer station) that is not scheduled to participate by the DR (that is not a power control target), and the correction unit 113 performs discharging control for the base station (the buffer station) (S206). For the selection of the base station and its discharging control, a base station that satisfies the difference between the power control amount and the required amount at time t is selected and controlled for discharging. Therefore, a plurality of base stations being buffer stations may be selected.

When it is possible to detect the surplus discharging station, the buffer station management unit 112 determines whether or not there is discharging time overlap and whether the surplus discharging station is currently being discharged (S204). The discharging time overlap can be determined on the basis of the duration of the base station placed by the BL method or the BR method.

When it is determined that there is time overlap (S204: YES), the buffer station management unit 112 selects a base station (a buffer station) that is not a power control target based on a DR request and the correction unit 113 performs discharging control for the base station (the buffer station) (S206).

When the buffer station management unit 112 determines that there is no time overlap (S204: NO), the correction unit 113 performs discharging control for the surplus discharging station among the base stations that are power control targets based on the DR request (S205).

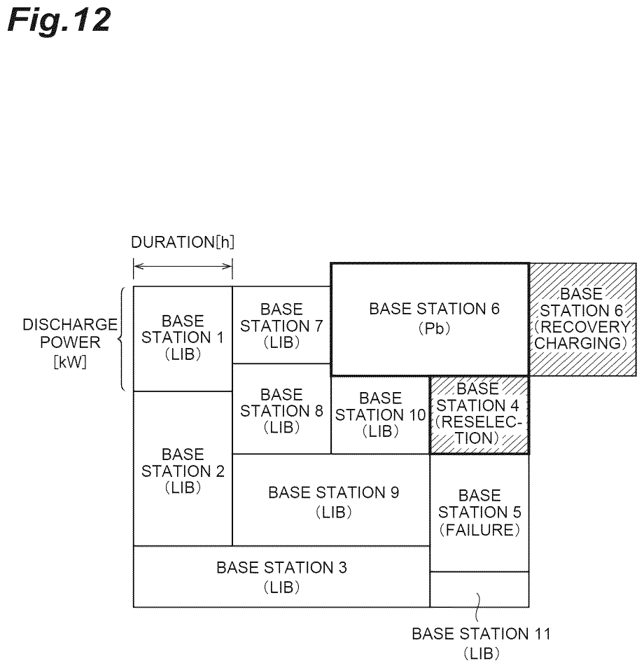

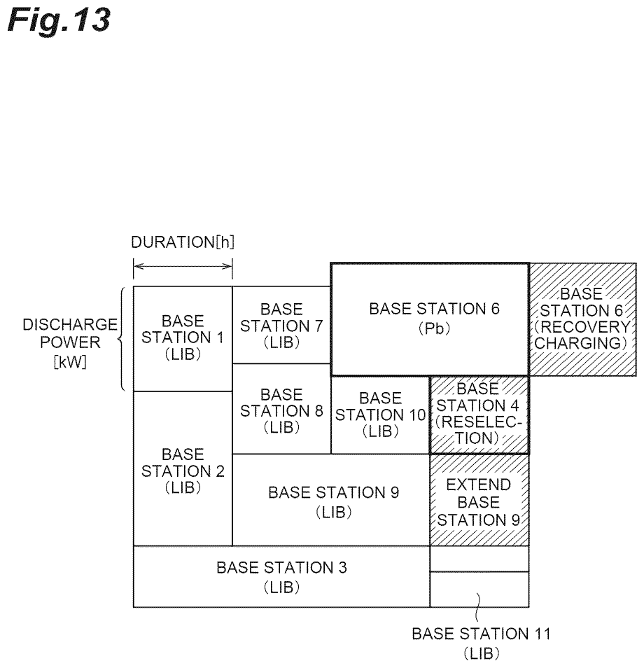

FIGS. 12 and 13 are schematic diagrams of a case where base station selection for additional discharge power control is performed. As shown in FIGS. 12 and 13, it is assumed that the base station 5 has failed. The buffer station management unit 112 detects a buffer station or a correction station to satisfy a DR-specific required amount. In FIG. 13, the base station 9 is determined to be a surplus discharging station and used as a correction station. Also, a control process is performed so that the required amount is satisfied by extending the discharging time of the correction station.

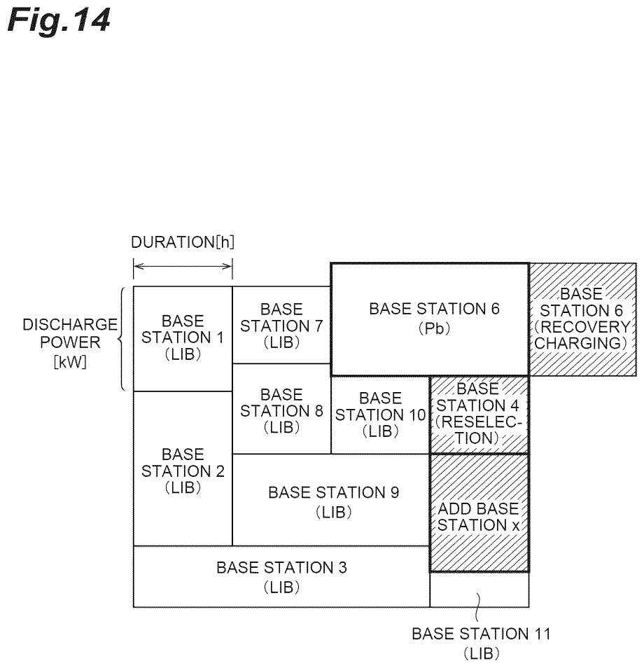

FIG. 14 is an example of a case where a buffer station is added. As shown in FIG. 14, the buffer station management unit 112 detects a base station x when there is the base station x that is not scheduled to participate in the DR and the correction unit 113 performs discharging control using the base station x as a buffer station.

Next, the process at the time of an upward DR will be described on the basis of FIG. 11. As described above, because the processing steps S111 to S119 are the same as in FIG. 5, the description thereof is omitted.

The control amount measurement unit 111 measures the power control amount of each base station in real time and determines whether or not the power control amount has fallen below the required amount by deviating from the error range (S211). That is, the control amount measurement unit 111 determines whether or not the power control amount x(t) at time t is greater than the required amount A (a required amount at time t). Here, the power control amount x indicates an amount of charge.

When the power control amount x(t) is greater than the required amount A (the required amount at time t), the control amount measurement unit 111 iterates this check process until the DR is completed (S212).

When the power control amount at time t during the DR activation time is less than the required amount at that time t, the buffer station management unit 112 detects a base station (a surplus charging station group) with a storage battery having a spare capacity for charging beyond the duration from among the base stations that are the power control targets based on the DR (S213).

When there is no surplus charging station, the buffer station management unit 112 selects a base station (a buffer station) that is not a power control target based on the DR, and the correction unit 113 performs charge control for the base station (the buffer station) (S216). For the selection of the base station and its charging control, a base station that satisfies the difference between the power control amount (the charge amount) and the required amount at time t is selected and controlled for charging. Therefore, a plurality of base stations being buffer stations may be selected.

When a surplus charging station can be detected, the buffer station management unit 112 determines whether or not there is charging time overlap, i.e., whether or not the surplus charging station is currently being charged (S214).

If it is determined that there is time overlap (S214: YES), the buffer station management unit 112 selects a base station (a buffer station) that is not a power control target based on the DR request and the correction unit 113 performs charging control for the base station (the buffer station) (S216).

When the buffer station management unit 112 determines that there is no time overlap (S214: NO), the correction unit 113 performs charging control for the correction station (the surplus charging station among the base stations that are power control targets based on the DR) (S215).

In the DC power supply system according to the first embodiment and the second embodiment, the load device is not limited to a communication device. Naturally, the DC power supply system is not limited to base stations. The DC power supply system may be a facility equipped with some type of storage battery and a load device capable of supplying power from the storage battery.

The DC power supply system according to the above embodiment relates to a configuration in which a lead-acid battery and a lithium-ion battery are mixed, but may have another battery having different charging/discharging characteristics and a different charging method. In the DC power supply system according to the above-described embodiment, the power flow of the rectifier/storage battery is determined according to voltage control, but electric current control may also be used.

Next, the operating effects of the server 100 and the server 100a of the present disclosure will be described.

The server 100 of the present disclosure is a control device that performs power control for one or more base stations 1 to n (facilities) including a communication device 13 (a load device) and a storage battery that supplies electric power to the communication device 13. In the server 100, the DR request communication unit 101 receives a DR request (a power control request) from the power supplier. The base station selection unit 107 selects a base station being a DR request target on the basis of a type of storage battery of each of one or more base stations. The type of storage battery is, for example, a lithium-ion battery or a lead-acid battery, and has a different degree of deterioration due to charging and discharging.

According to this configuration, the base station being a power control target can be appropriately selected in accordance with the type of storage battery provided in the base station. If the type of storage battery is information indicating the degree of deterioration due to charging/discharging, the deterioration of the storage battery due to the charging/discharging can be reduced.

Moreover, in the server 100 of the present disclosure, the base station selection unit 107 selects one or more base stations being power control targets from one or more base stations having a specific type of storage battery (for example, a lithium-ion battery) so that the required amount of power control based on the DR request (the power control request) is satisfied.

The duration calculation unit 105 calculates the power control amount on the basis of the charge/discharge power P in the storage battery and the current capacity W of the storage battery in each base station with a specific type of storage battery (for example, a lithium-ion battery) and the base station selection unit 107 selects the base station on the basis of the power control amount.

When the power control amount at the selected base station does not satisfy the required amount based on the DR request, the base station selection unit 107 selects a base station with a storage battery (for example, a lead-acid battery) having a lower priority level.

When a base station including a type of storage battery (for example, a lead-acid battery) with a lower priority level in terms of charging and discharging has been selected, the base station selection unit 107 readjusts a charging/discharging time of the storage battery of the base station including a type of storage battery with a higher priority level (for example, a lithium-ion battery).

When the base station selection unit 107 selects a base station including a type of storage battery (for example, a lead-acid battery) having a lower priority level related to charging, the base station selection unit 107 calculates the discharging start time for the base station.

According to this configuration, when an upward DR (consumption request) among the DR requests is received, the recovery charging of a type of storage battery (a lead-acid battery) with a lower priority level can be used to respond to the upward DR. That is, the storage battery that performs the recovery charging is discharged in advance, but it is possible to respond to the consumption request by performing the recovery charging in accordance with the start of the upward DR.

Moreover, when the DR request communication unit 101 receives a downward DR (a power-saving request) as a power control request, the duration calculation unit 105 calculates the discharging duration on the basis of discharge power of the specific type of storage battery, the current capacity of the storage battery, and the minimum required backup capacity of the storage battery. Also, the base station selection unit 107 decides the discharging time for each base station on the basis of the discharging duration and the discharge power.

Moreover, when the DR request communication unit 101 receives an upward DR (consumption request) as the power control request, the charging duration is calculated on the basis of the charge power in the specific type of storage battery, the current capacity of the storage battery, and the maximum capacity of the storage battery. Also, the base station selection unit 107 decides the charging time for each base station on the basis of the charging duration and the charge power.

Moreover, when the control amount measurement unit 111 determines that the charge/discharge amount in each storage battery at one point in time (time t) is less than a required amount based on the DR request (the power control request) (a required amount), the buffer station management unit 112 selects a facility that is not a power control target. The charging/discharging instruction unit 110 performs power control for the storage battery of the base station. That is, the base station selection unit 107 compares the charge/discharge amount at x(t) with the required amount at that time (time t) in real time. When the charge/discharge amount is less than the required amount, a facility that is not the power control target is selected as described above.

Thereby, even if the base station to be charged and discharged fails and no longer satisfies the required amount, a replacement base station can be selected to operate so that the required amount is satisfied.

Moreover, when the control amount measurement unit 111 determines that the charge/discharge amount of each storage battery at one point in time falls below the required amount of power control based on the power control request, the correction unit 113 performs power control for the facility that is a power control target and is capable of power control.

Thereby, even if the base station to be charged and discharged fails and does not satisfy the required amount, it is possible to perform an operation of satisfying the required amount by further enabling charging and discharging for the base station that enables the surplus charging and discharging.

The servers 100 and 100a disclosed herein have the following functional configuration as control devices.
[1]
A control device for performing power control for one or more facilities including a load device and a storage battery for supplying electric power to the load device, the control device comprising:
a reception unit configured to receive a power control request from a power supplier; and
a control unit configured to select a facility being a target of the power control request on the basis of a type of storage battery of each of the one or more facilities.
[2]
The control device according to [1], wherein the control unit selects one or more facilities being a power control target from one or more facilities having a specific type of storage battery so that a power control request amount based on the power control request is satisfied.
[3]
The control device according to [1] or [2], wherein the control unit calculates a power control amount on the basis of charge and discharge power in the storage battery and a current capacity of the storage battery in each facility having a specific type of storage battery, and wherein the control unit selects the facility on the basis of the power control amount.
[4]
The control device according to [2] or [3], wherein the control unit selects a facility having a lower priority level when the power control amount in the selected facility does not satisfy the required amount.
[5]
The control device according to [4], wherein the control unit readjusts at least one of charging and discharging times of the storage battery of a facility including a type of storage battery with a high priority level when a facility including a type of storage battery with a low priority level related to at least one of charging and discharging is selected.
[6]
The control device according to [4] or [5], wherein the control unit calculates a discharging start time for a facility including a type of storage battery with a low priority level related to charging when the facility is selected.
[7]
The control device according to any one of [3] to [6], wherein, when a power-saving request has been received as the power control request, the control unit calculates discharging duration on the basis of discharge power in the specific type of storage battery, a current capacity of the storage battery, and a minimum required backup capacity in the storage battery, and
wherein the control unit decides a discharging time for each facility on the basis of the discharging duration and the discharge power.
[8]
The control device according to any one of [3] to [7], wherein, when a consumption request has been received as the power control request, the control unit calculates charging duration on the basis of charge power in the storage battery, a current capacity of the storage battery, and a maximum capacity of the storage battery, and wherein the control unit decides a charging time for each facility on the basis of the charging duration and the charge power.
[9]
The control device according to any one of [1] to [8], wherein, when at least one of charge and discharge amounts in each storage battery is less than a required amount based on the power control request at a point in time, the control unit selects a facility that is not a power control target and performs power control for the storage battery of the facility.
[10]
The control device according to any one of [1] to [9], wherein, when at least one of charge and discharge amounts in each storage battery is less than a required amount of power control based on the power control request at a point in time, the control unit further performs power control for a facility in which power control is possible among facilities of power control targets.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

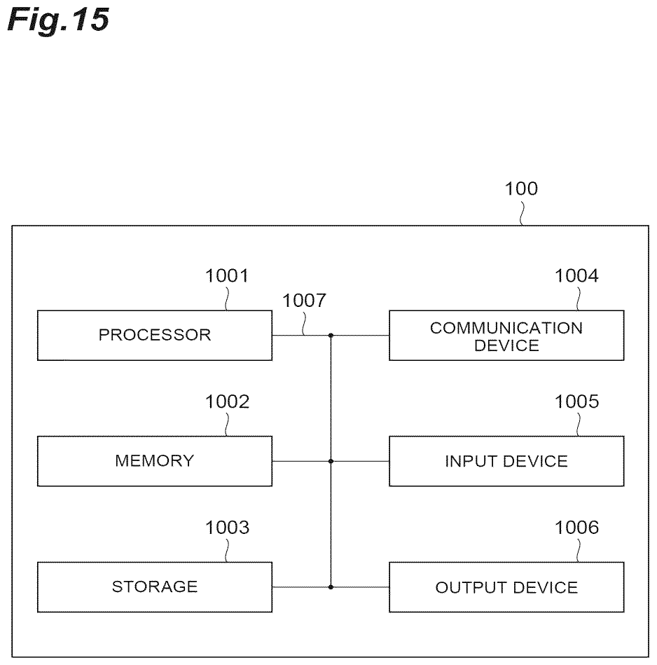

For example, the server 100 (and server 100a) and the like according to one embodiment of the present disclosure may function as a computer that performs processing of a charge and discharge control method according to the present disclosure. FIG. 15 is a view showing an example of the hardware configuration of the server 100 according to one embodiment of the present disclosure. The server 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the server 100 may be configured to include one or a plurality of the devices shown in the drawings or may be configured without including some of those devices.

The functions of the server 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the duration calculation unit 105, the base station selection unit 107, the lead-acid battery station addition unit 108, the lithium-ion battery station reselection unit 109 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the duration calculation unit 105 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing a storage battery control method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described DR request communication unit 101 and the charging/discharging instruction unit 110 may be implemented by the communication device 1004. The DR request communication unit 101 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the server 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning.

Further, information, parameters and the like described in the present disclosure may be represented by an absolute value, a relative value to a specified value, or corresponding different information. For example, radio resources may be indicated by an index.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

11 Smart meter, 12 Rectifier, 13 Communication device, 14 Storage battery, 100 Server, 101 DR request communication unit, 102 Discharge power detection unit, 103 Storage battery capacity detection unit, 104 Storage unit, 105 Duration calculation unit, 106 Storage battery type detection unit, 107 Base station selection unit, 108 Lead-acid battery station addition unit, 109 Lithium-ion battery station reselection unit, 110 Charging/discharging instruction unit, 111 Control amount measurement unit, 112 Buffer station management unit, 113 Correction unit

1. A control device for performing power control for one or more facilities including a load device and a storage battery for supplying electric power to the load device, the control device comprising:
a reception unit configured to receive a power control request from a power supplier; and
a control unit configured to select a facility being a target of the power control request on the basis of a type of storage battery of each of the one or more facilities.

2. The control device according to claim 1, wherein the control unit selects one or more facilities being a power control target from one or more facilities having a specific type of storage battery so that a power control request amount based on the power control request is satisfied.

3. The control device according to claim 1,
wherein the control unit calculates a power control amount on the basis of charge and discharge power in the storage battery and a current capacity of the storage battery in each facility having a specific type of storage battery, and
wherein the control unit selects the facility on the basis of the power control amount.

4. The control device according to claim 2, wherein the control unit selects a facility having a lower priority level when the power control amount in the selected facility does not satisfy the required amount.

5. The control device according to claim 4, wherein the control unit readjusts at least one of charging and discharging times of the storage battery of a facility including a type of storage battery with a high priority level when a facility including a type of storage battery with a low priority level related to at least one of charging and discharging is selected.

6. The control device according to claim 4, wherein the control unit calculates a discharging start time for a facility including a type of storage battery with a low priority level related to charging when the facility is selected.

7. The control device according to claim 3,
wherein, when a power-saving request has been received as the power control request, the control unit calculates discharging duration on the basis of discharge power in the specific type of storage battery, a current capacity of the storage battery, and a minimum required backup capacity in the storage battery, and
wherein the control unit decides a discharging time for each facility on the basis of the discharging duration and the discharge power.

8. The control device according to claim 3,
wherein, when a consumption request has been received as the power control request, the control unit calculates charging duration on the basis of charge power in the storage battery, a current capacity of the storage battery, and a maximum capacity of the storage battery, and
wherein the control unit decides a charging time for each facility on the basis of the charging duration and the charge power.

9. The control device according to claim 1, wherein, when at least one of charge and discharge amounts in each storage battery is less than a required amount based on the power control request at a point in time, the control unit selects a facility that is not a power control target and performs power control for the storage battery of the facility.

10. The control device according to claim 1, wherein, when at least one of charge and discharge amounts in each storage battery is less than a required amount of power control based on the power control request at a point in time, the control unit further performs power control for a facility in which power control is possible among facilities of power control targets.
